(19) United States
(12) Patent Application Publication
(10) Pub. No.: US 2017/0097518 A1
(43) Pub. Date: Apr. 6, 2017

(54) EYEGLASSES WITH CHANGEABLE FRAME

(71) Applicant: SUN SIGHT GLASSES CO., LTD., TAINAN (TW)

(72) Inventor: JUI-CHI LI, TAINAN (TW)

(21) Appl. No.: 14/874,786

(22) Filed: Oct. 5, 2015

(51) Int. Cl. G02C 1/08; G02C 1/04

(52) U.S. Cl. CPC G02C 1/08; G02C 1/04; G02C 2200/08; G02C 2200/06

(57) ABSTRACT

Eyeglasses with a changeable frame are revealed. The eyeglasses with a changeable frame include an eyeglass frame and a half frame set under the eyeglass frame. The eyeglass frame is disposed with left and right lenses while temples are connected to two outer sides thereof respectively. A lower half of each lens is exposed outside the eyeglass frame. The half frame includes a mounting slot for receiving the lenses and a connecting support piece disposed on top thereof. The connecting support piece is for connecting the eyeglass frame. The connecting support piece is set with a locking block while a mounted block and a projecting pin are disposed on each of two sides of the half frame. Thus the eyeglass frame and the half frame are connected stably. Thereby users can select half frame or full frame eyeglasses according to their needs and have different looks.

### BACKGROUND OF THE INVENTION

Field of the Invention

The present invention relates to eyeglasses, especially to eyeglasses with a changeable frame and having various styles by a half frame capable of being assembled and disassembled.

Descriptions of Related Art

Generally, eyewear is divided into various types such as sunglasses, optical glasses, sports glasses, safety glasses, etc. according to their uses and functions. Most of the optical glasses use a full frame where lenses are completed surrounded and secured while a half frame is used in sports glasses and safety glasses. Thus users feel easy and convenient while doing outdoor activities, sporting or working.

Many of the young people really care about their appearance. This makes eyeglasses become a fashionable accessory. There are various designs of the eyeglass frame that is not only changed with the fashion but also creating fashion trends. Users can choose the eyewear according to their needs. Each consumer has his own tastes so that different consumers choose eyewear with different uses and function and their favorite eyeglass frames have different styles. The eyeglasses available in the eyeglass stores can be a full frame type, a half frame type, or even a frameless type. For eyeglass retailers, the operating cost is increased. As to the consumers, they can buy glasses with different frames and choose the one they require according to occasions or styles. Each eyeglass frame is mated with a pair of lenses. Thus the expenses the consumers spent on the eyeglasses are also raised.

Refer to Taiwanese Pat. Pub. No. M449971U1, eyeglasses with a changeable frame are revealed. The eyeglasses include an upper frame and a lower frame. A lens assembly portion is formed on the upper frame and the lower frame respectively. The upper frame and the lower frame are disposed with mounting holes and mounting blocks respectively. The mounting holes and the mounting blocks are corresponding to and mounted with each other so that the upper frame and the lower frame are integrated into one part. Although the above design allows users to disassemble the upper frame and the lower frame and switch the eyeglasses between a half frame type and a full frame type, the upper frame and the lower frame are not connected to and fixed on each other firmly only by the mounting holes and mounting blocks mated correspondingly. When there is an improper force applied, or collision, the lower frame is easy to fall off or the mounting block is cracked. This is inconvenient in use.

Thus there is room for improvement and a need to provide novel eyeglasses with a changeable frame that overcomes the above shortcomings.

### SUMMARY OF THE INVENTION

Therefore it is a primary object of the present invention to provide eyeglasses with a changeable frame and having various styles by a half frame capable of being assembled and disassembled.

In order to achieve the above object, eyeglasses with a changeable frame of the present invention consist of an eyeglass frame and a half frame set under the eyeglass frame. Left and right lenses are set on the eyeglass frame and a lower half of each lens is exposed outside the eyeglass frame while temples are connected to two outer sides of the eyeglass frame respectively. The half frame is disposed with a mounting slot for receiving the lenses and is arranged with a connecting support piece on top thereof. The connecting support piece is used to connect to the eyeglass frame. The connecting support piece is set with a locking block while a mounted block and a projecting pins are arranged each of two sides of the half frame. Thus the half frame and the eyeglass frame are connected firmly. Thereby users can select a half frame type or a full frame type of eyeglasses according to their needs and change their styles.

A locking slot corresponding to the locking block of the connecting support piece is arranged at the eyeglass frame.

A stopping edge is disposed over the locking block and is against a top edge of the eyeglass frame.

The eyeglass frame is disposed with mounting slots corresponding to and used for mounting the mounted blocks of the connecting support piece.

The eyeglass frame is further arranged with mounting holes corresponding to the projecting pins of the half frame. The projecting pin is mounted and positioned in the mounting hole correspondingly.

The followings are advantages of the present invention:
1. The eyeglasses with a changeable frame of the present invention provides users more options including the full frame type and the half frame type by the half frame capable of being assembled and disassembled.
2. The connecting support piece not only makes the half frame have higher assembly strength, better connection with the eyeglass frame and less damage.
3. By the design of multiple mounting points including the locking block locked in the locking slot, the mounted blocks mounted in the mounting slots and the projecting pins locked in the mounting hole, the eyeglass frame and the half frame are connected to each other firmly, hard to separate from each other.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein:

FIG. 1 is an explosive view of an embodiment according to the present invention;

FIG. 2 is another explosive view of an embodiment according to the present invention;

FIG. 3 is a perspective view of a full frame type of an embodiment according to the present invention;

FIG. 4 is a longitudinal sectional view of a bridge of an embodiment according to the present invention;

FIG. 5 is a top view of a cross section of an embodiment according to the present invention;

FIG. 6 is a partial longitudinal view of an outer side of an embodiment according to the present invention.

### DETAILED DESCRIPTION OF THE PREFERRED EMBODIMENT

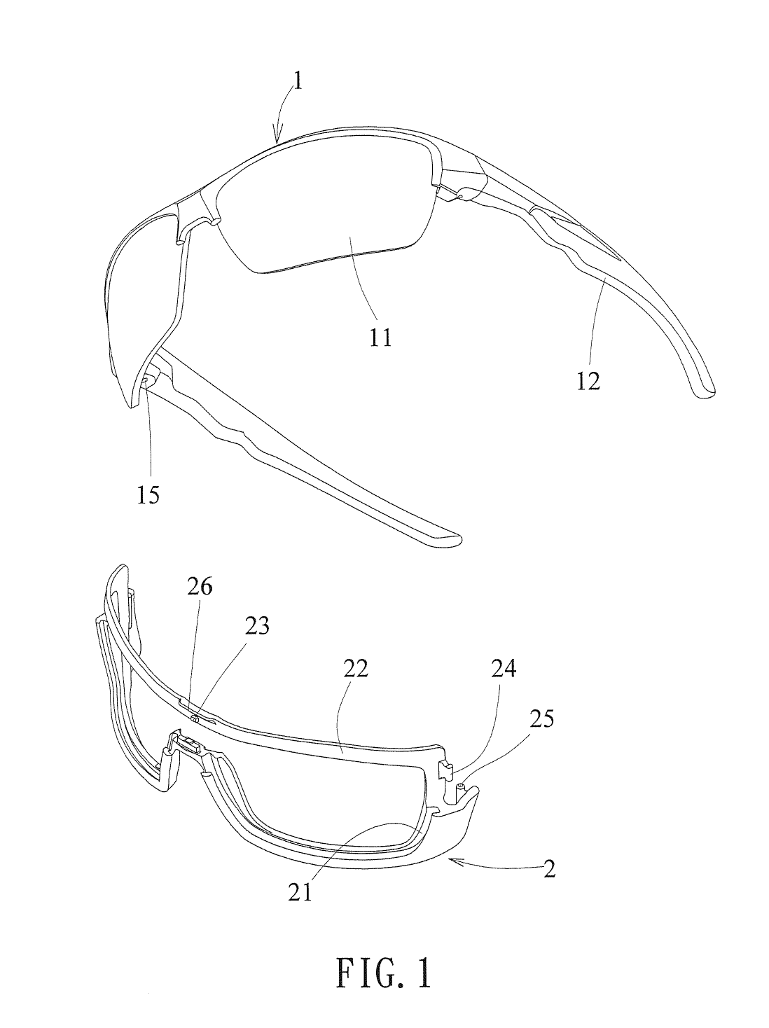

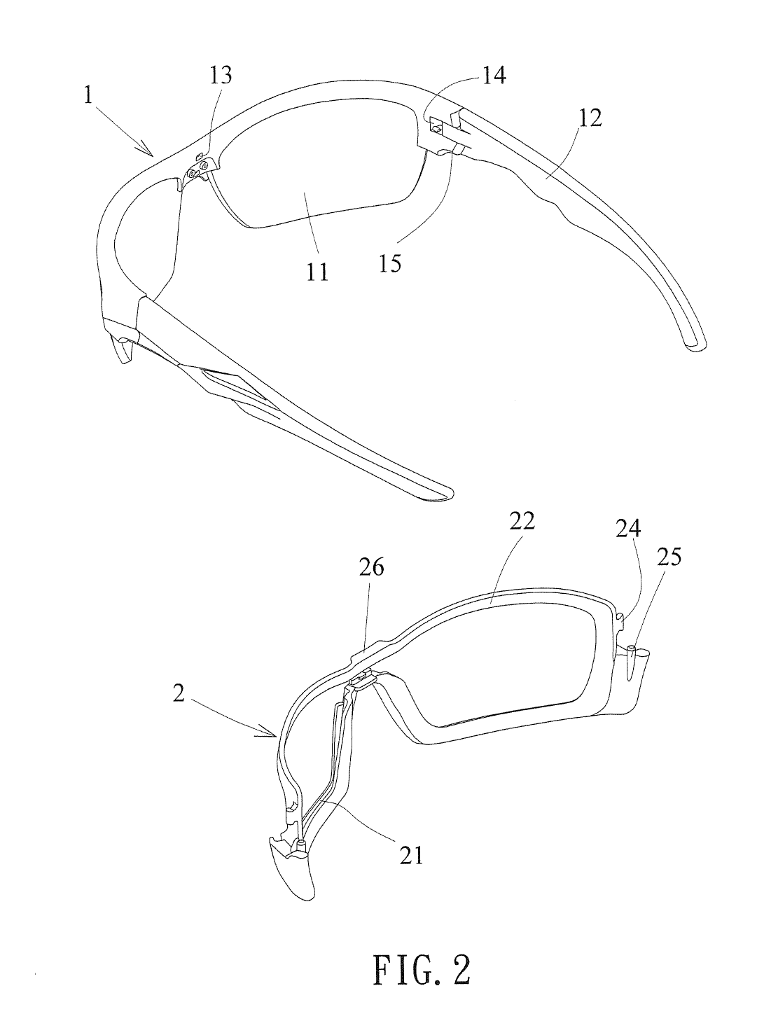

Refer to FIG. 1 and FIG. 2, eyeglasses with a changeable frame includes an eyeglass frame 1 and a half frame 2.

The eyeglass frame 1 is disposed with left and right lenses 11 while temples 12 are connected to two outer sides thereof respectively. A lower half of each lens 11 is exposed outside the eyeglass frame 1.

The half frame 2 is corresponding to, fixed on the eyeglass frame 1 and including a mounting slot 21 for receiving the lenses 11 exposed outside the eyeglass frame 1.

The eyeglasses with a changeable frame feature on that a locking slot 13 arranged at an inner surface of a bridge of the eyeglass frame 1 and a connecting support piece 22 disposed on top of the half frame 2. The connecting support piece 22 is set with a locking block 23 on a top side and two mounted blocks 24 on two lateral sides respectively while the eyeglass frame 1 is set with mounting slots 14 on two lateral sides. The locking block 23 is mated with the locking slot 13 of the eyeglass frame 1 while the mounted blocks 24 are mounted and fixed into the mounting slots 14. The eyeglass frame 1 is further arranged with mounting holes 15 on bottom of the two lateral sides respectively. Two projecting pins 25 corresponding to and positioned in the mounting holes 15 are disposed on the half frame 2.

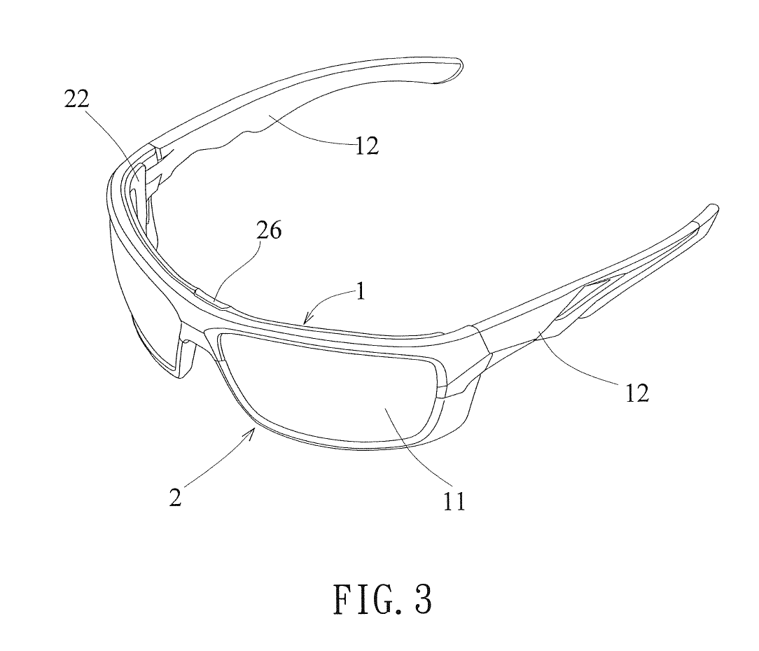

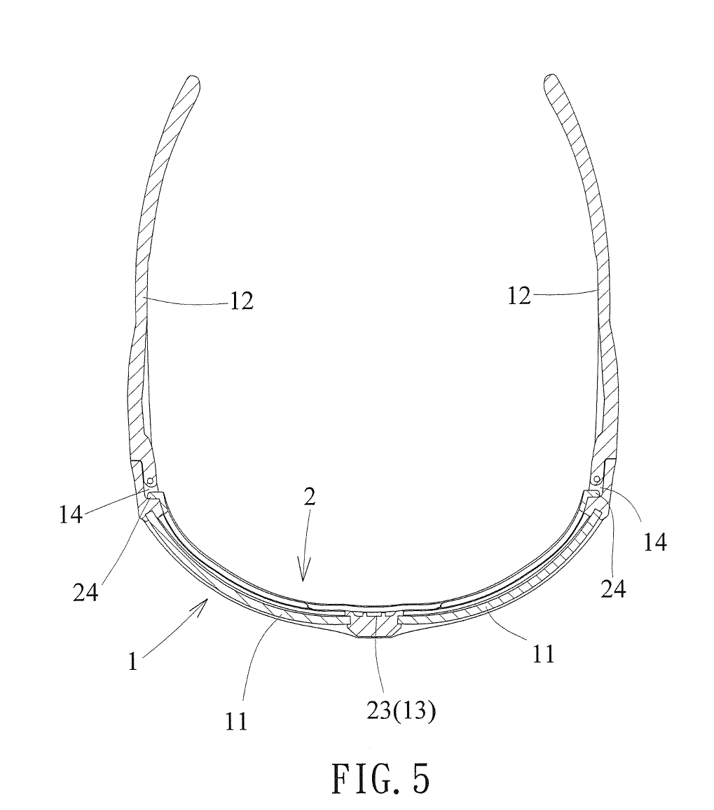

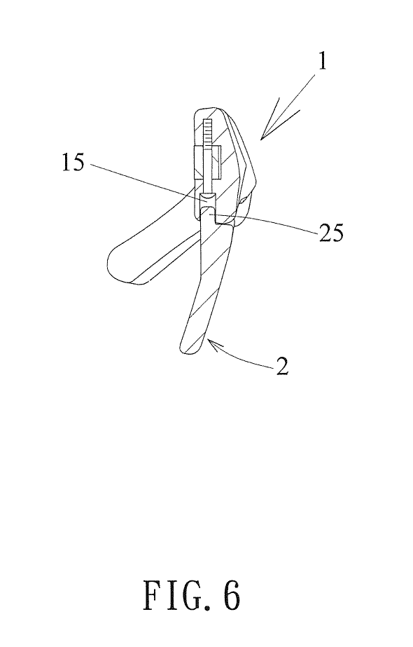

Refer to FIG. 1 to FIG. 6. While in use, the eyeglasses can be either a half frame type, or a full frame type according to user's needs. When the eyeglasses are the half frame type, the eyeglass frame 1 is a half frame type. When the eyeglasses are the full frame type, the half frame 2 is assembled with and fixed on the eyeglass frame 1. The lenses 11 are mounted in the mounting slot 21 so that the lenses 11 exposed outside the eyeglass frame 1 are surrounded. At the same time, the locking block 23 on the connecting support piece 22 of the half frame 2 is correspondingly mounted into the locking slot 13 at the bridge of the eyeglass frame 1 while the mounted blocks 24 on the lateral sides of the connecting support piece 22 of the half frame 2 are mounted into the mounting slots 14 of the eyeglass frame 1 correspondingly. Thus the eyeglass frame 1 and the half frame 2 are clamped and connected to each other firmly. Moreover, the projecting pins 25 of the half frame 2 are locked into the mounting holes 15 of the eyeglass frame 1 for being stopped and fixed. Thereby the assembly of the full frame eyeglasses is completed. Users can choose the full frame or half frame eyeglasses according to their needs and have many different styles.

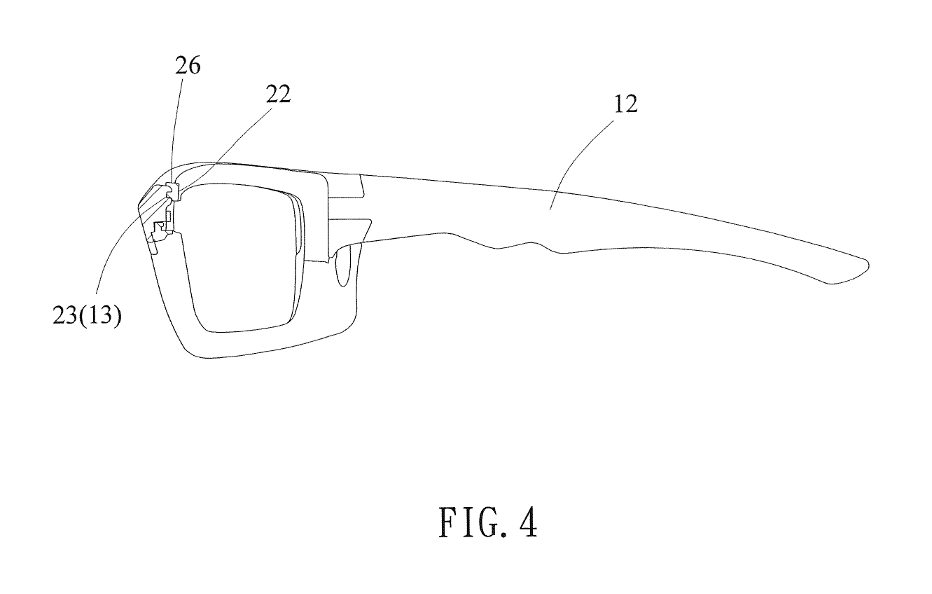

Furthermore, refer to FIG. 4, a stopping edge 26 is disposed over the locking block 23 for allowing the connection between the connecting support piece 22 of the half frame 2 and the eyeglass frame 1 more stably. The stopping edge 26 is against a top edge of the eyeglass frame 1. Thus the half frame 2 is firmly fixed on the eyeglass frame 1, without falling off.

In summary, the present invention has the following advantages compared with the structure available now.
1. By the half frame able to be removed and assembled, the eyeglasses with a changeable frame of the present invention can be the full frame type or the half frame type. Users have more options while in use.
2. The half frame of the eyeglasses has higher assembly strength, better connection with the eyeglass frame and less damage due to the arrangement of the connecting support piece.
3. By the design of multiple mounting points including the locking block locked in the locking slot, the mounted blocks mounted in the mounting slots and the projecting pins locked in the mounting hole, the eyeglass frame and the half frame are assembled firmly, without falling off.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalents.

1. Eyeglasses with a changeable frame comprising:
an eyeglass frame disposed with a left lens, a right lens, and temples on two outer sides thereof; a lower half of the left lens and a lower half of the right lens exposed outside the eyeglass frame; and
a half frame fixed on and connected to the eyeglass frame correspondingly and having a mounting slot for receiving the left lens and the right lens of the eyeglass frame, and surrounding the lower half of the left lens and the lower half of the right lens exposed outside the eyeglass frame;
wherein a locking slot is arranged at an inner surface of a bridge of the eyeglass frame and a connecting support piece is disposed on top of the half frame; the connecting support piece is set with a locking block; the locking block corresponds and connects to the locking slot of the eyeglass frame; the connecting support piece includes two mounted blocks on two sides thereof; the eyeglass frame is disposed with mounting slots that are used to receive the mounted blocks correspondingly; the eyeglass frame is further arranged with a mounting hole on a bottom of each of two sides while projecting pins corresponding to the mounting holes are disposed on the half frame; the projecting pins are mounted and positioned in the mounting holes.

2. The device as claimed in claim 1, wherein a stopping edge is disposed over the locking block and is against a top edge of the eyeglass frame.
